(19) United States
(12) Patent Application Publication
(10) Pub. No.: US 2005/0005116 A1
(43) Pub. Date: Jan. 6, 2005

(54) Dynamic interoperability contract for web services

(75) Inventors: Jayaram Rajan Kasi, San Jose, CA (US); Rashmi Murthy, Campbell, CA (US); Symon Szu-Yuan Chang, Fremont, CA (US); Todd Christopher Klaus, San Jose, CA (US); Helen S. Yuen, Oakland, CA (US)

Correspondence Address: HAYNES BEFFEL & WOLFELD LLP, P O BOX 366, HALF MOON BAY, CA, 94019, US

(73) Assignee: Commerce One Operations, Inc., Pleasanton, CA (US)

(21) Appl. No.: 10/246,592

(22) Filed: Sep. 18, 2002

(51) Int. Cl. H04L 9/00

(52) U.S. Cl. 713/170

(57) ABSTRACT

The present invention relates to machine-readable data structures and dynamic calculation of data structures to support interoperability. More particularly, it relates to aspects of data structures that enhance interoperability and dynamic generation of the data structures. Particular aspects of the present invention are described in the claims, specification and drawings.

### RELATED APPLICATIONS

This application is related to the commonly owned U.S. Letters patent applic. Ser. No. 10/199,967, entitled “Electronic Commerce Community Networks and Intra/Inter Community Secure Routing Implementation”, by inventors Raghunath Sapuram, Jayaram Rajan Kasi, Todd Klaus, Christopher Crall, and Joseph Sanfilippo, filed on 19 Jul. 2002 and incorporated herein by reference. This application also is related to the commonly owned U.S. Letters patent applic. Ser. No. 10/199,963, entitled “Registry Driven Interoperability and Exchange of Documents”, by inventors Christopher Todd Ingersoll, Jayaram Rajan Kasi, Alexander Holmes, Michael Clark, Ashok Aletty, Sathish Babu K. Senathi, and Helen S. Yuen, filed on 19 Jul. 2002 and incorporated herein by reference.

This application is related to two commonly owned U.S. Letters Patent Applications filed the same day as this application, entitled “Exposing Process Flows And Choreography Controllers As Web Services”, by inventors Jayaram Rajan Kasi, Vinkesh Omprakash Mehta, Raghunath Sapuram, and Ram Shankar and entitled “Dynamic Negotiation Of Security Arrangements Between Web Services”, by inventors Symon Szu-yuan Chang, Joseph S. Sanfilippo, Jayaram Rajan Kasi, and Chris Crall. The two applications filed the same day are hereby incorporated by reference.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### REFERENCE TO COMPUTER PROGRAM LISTING APPENDIX

A computer program listing appendix comprising duplicate copies of a compact disc, named “CM1024,” accompanies this application and is incorporated by reference. The computer program listing appendix includes the following files:

| | | |
|---|---|---|
| InteroperabilityContract.xsd | 3,696 bytes | created 8/16/2002 |
| (File containing schema for | | |
| overall contract.) | | |
| GeneralContract.XSD | 12,297 bytes | created 8/16/2002 |
| (File containing schema for | | |
| general information.) | | |
| RoutingContract.XSD | 5,250 bytes | created 8/16/2002 |
| (File containing schema for | | |
| routing of messages.) | | |
| TransformationContract.XSD | 3,321 bytes | created 8/16/2002 |
| (File containing schema for | | |
| transformation of documents.) | | |
| SecurityContractKeyInfo.XSD | 15,089 bytes | created 8/16/2002 |
| (File containing schema for | | |
| keys used for security.) | | |
| SecurityContract.XSD | 14,496 bytes | created 8/16/2002 |
| (File containing schema for security | | |
| contract output from negotiation.) | | |
| InteroperabilityContract.XML | 18,432 bytes | created 9/18/2002 |
| (File containing example of | | |
| interoperability contract.) | | |
| ComputeSecurityContract.XML | 4,689 bytes | created 9/12/2002 |
| (File containing computed security | | |
| contract in example.) | | |

### BACKGROUND OF THE INVENTION

The present invention relates to machine-readable data structures and dynamic calculation of data structures to support interoperability. More particularly, it relates to aspects of data structures that enhance interoperability and dynamic generation of the data structures. Particular aspects of the present invention are described in the claims, specification and drawings.

Business-to-business (B2B) and application-to-application (A2A) electronic commerce are replacing former protocols for electronic data interchange (EDI). As businesses strive to improve their efficiency with B2B and A2A systems, a number of incompatible platforms and competing standards have emerged. Among compatible standards, gaps remain to be filled. For instance, the industry has defined what a simple web service is. Standards related to simple Web service include UDDI, WSDL, XSDL and SOAP. However, these standards do not fully meet the security, reliability, manageability, and choreography requirements for practical B2B and A2A electronic commerce. Security in particular presents numerous options and configuration issues. Collaborative web services and their security needs are expected to evolve as non-web businesses do. There is no any comprehensive or unified device or method that dynamically resolves and updates security options and configurations as web services evolve.

There are a number of industry initiatives to extend standards applicable to B2B and A2A electronic commerce. Choreography efforts include ebXML/BPSS from OASIS, WSFL from IBM, and XLANG from Microsoft. Conversation efforts include ebXML/TRP from OASIS and Microsoft's WS-routing. Further information regarding ebXML initiatives is available at http://www.ebxml.org/specs/index.htm# whitepapers, where the article “Collaboration-Protocol Profile and Agreement Specification Version 1.0”, by ebXML Trading-Partners Team (May 10, 2001) is found. Some information also is found in U.S. Pat. No. 6,148,290, for unambiguous rules of interaction and service contract enforcer logic. The dominant security effort is WS-security from IBM and Microsoft, there is also a complementary security effort in OASIS called SAML. For reliability, there are proposals from Microsoft, ebXML/TRP from OASIS, and HTTPR from IBM. W3C is addressing standardization in all of these areas. Key industry players have formed a rival consortium called WSI. However, they have not addressed the dynamic security negotiation issue.

In ebXML CPP and CPA, the parties interoperating define the profile called a CPP for their interoperation rules for their services in a single registry. The two profiles can be intersected to deduce the default interoperation agreement called a CPA. Alternatively the two parties agree on a specific set of interoperation rules between called a CPA. The problems with ebXML CPP and CPA include: They assume that the sending and receiving parties are in the same registry. The interoperation rules are insufficient to cover many aspects of interoperation. When used, they assume that a signed copy (signed by both parties) of the CPA is kept in a registry. This makes it cumbersome to maintain and modify. It is directly inconsistent with dynamically computing an interoperability agreement. Accordingly, instead of addressing dynamic computation with caching at runtime when a services invokes another service, but the talks about pre-downloading and local installation, which makes managing changes to the CPA difficult and not automatic.

Accordingly, an opportunity arises to develop methods and devices that dynamically determine interoperability agreements for trading partners.

### SUMMARY OF THE INVENTION

The present invention relates to machine-readable data structures and dynamic calculation of data structures to support interoperability. More particularly, it relates to aspects of data structures that enhance interoperability and dynamic generation of the data structures. Particular aspects of the present invention are described in the claims, specification and drawings.

### BRIEF DESCRIPTION OF THE DRAWINGS

FIG. 1 illustrates communities and networks of communities, which are one environment in which machine-readable, dynamically negotiated interoperability contracts are useful.

FIG. 2 illustrates multiple hub and spoke organizations that overlay the same connectors to support different transport/envelope protocols and technologies.

FIG. 3 illustrates alternative embodiments for obtaining receiver's information when the sender is local to calculations of the security, transformation and other arrangements.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

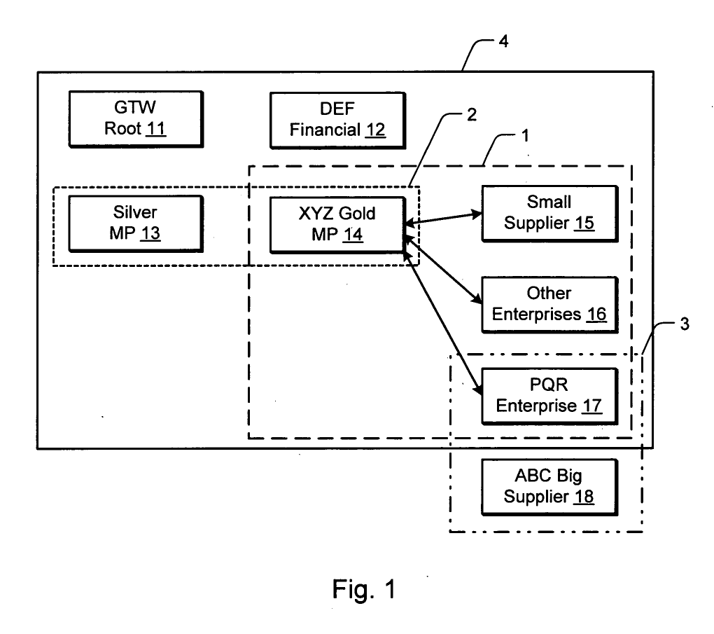

FIG. 1 illustrates communities and networks of communities, which are one environment in which machine-readable, dynamically negotiated interoperability contracts are useful. Among these communities, a community maintains a local registry that includes information such as users, companies, services and connectors that are part of the community. The community can be a marketplace, an enterprise or a sub enterprise. Communities can belong to one or more community networks. Typically, communities and networks have some common business interest. Interoperation is between member communities in one or more community networks. The networks include a gold marketplace network 1, a precious metal marketplace network 2, a private network 3 and a global trading web network 4. In this illustration, the gold marketplace network 1 and the precious metal marketplace network 2 are contained within the global trading web network 4. The precious metals marketplace network 2 includes gold and silver marketplaces 14, 13. Gold marketplace customers can trade silver in the silver marketplace 13 and silver marketplace customers can trade in gold 14. One community, PQR Enterprise 17 belongs to the gold marketplace network 1, the private network 3 and the global trading web network 4; another community, ABC Big Supplier 18 belongs to the private network 3. In this illustration, XYZ Gold 14 is a marketplace or community for trading gold. Enterprises belong to this community. Enterprises like PQR Enterprise 17 that have formed a community by themselves belong to the gold marketplace network 1. These communities are part of the gold marketplace network 1, and the global trading web network 4. Small supplier 15 is part of the gold marketplace community. Other enterprises 16 are communities that are part of the gold marketplace community network 1. The connections between XYZ Gold 14 and other gold marketplace entities 15-17 indicate that the gold marketplace requires all traffic between enterprises (communities or otherwise) transacting gold trading to be routed through XYZ Gold 14, for instance, to collect billing and business intelligence information. PQR Enterprise 17 is a community is part of the gold marketplace and also part of local private network with supplier 18. Small supplier 15 may be an individual small supplier that does not want to form a community by itself and instead registers its metadata, such as users, organizations, services and transformations, in the registry of the gold marketplace. On the other hand, ABC Big Supplier 18 has formed a private network of its own, for instance because it wants to keep its metadata, internal back office systems and transformations hidden from general public access because they were developed at considerable cost. Because PRQ 17 is a customer of ABC 18, it participates in the private network 3. Financial service provider DEF Financial 12 wants to provide financial services to anyone in the global trading web network 4, such forms a community of its own and registers with the global trading web root 11. A network of communities makes available a global registry of communities. The global registry permits lookup of the community and determination of one or more routes to that community, or to external connectors through which the electronic commerce documents bound for the community may be routed. Documents routed from one community to another may be routed directly between external connectors for the two communities or indirectly through one or more intermediary communities. Business and security rules for transactions involving the communities also can be defined and maintained in community registries. In general, FIG. 1 illustrates the mixed loyalties of entities and communities that create an impetus for interoperability among electronic commerce platforms.

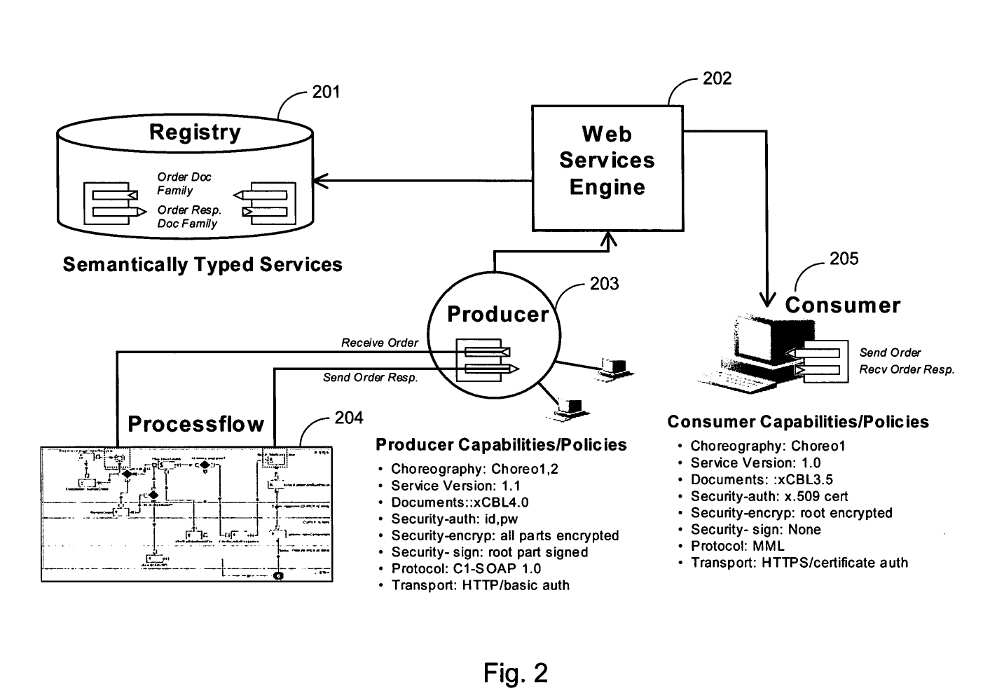

Connector is a general term for applications that communicate with other applications. Connectors may communicate on a peer-to-peer (P2P) basis or on a directed basis through other connectors that function as hubs, gateways, external ports, central connectors, etc. Connectors that communicate P2P are able to communicate with other connectors that use the same transport/envelope protocols. Connectors that communicate P2P optionally may enlist the assistance of other hub connectors that perform translation services, when trying to communicate with a connector that does not use the same transport/envelope protocol. Connectors that communicate on a directed basis communicate through hub connectors according to routing rules. Routing rules among connectors can be mapped in a directed graph, supporting one or more hub and spoke topologies for one or more transport/envelope protocols. A hub and spoke topology directs communications along spokes to hubs, in one or more tiers. This facilitates centralized services such as billing, business intelligence collection, tracking, auditing, accounting, or others. Multiple hub and spoke organizations may overlay the same connectors to support different transport/envelope protocols and technologies, as suggested by FIG. 2. For instance, a stronger hub and spoke organization may be required to use Sonic as a transport technology than to use HTTP or HTTPS. Optionally, communication routes may depend on whether the source and destination are part of the same community. Within a sub-community (which may include the whole community), centralized functions may be unneeded and P2P communications permitted among connectors that otherwise are directed to communicate with parent connectors when communicating with destinations in other sub-communities.

Connectors may be labeled simple connectors (sometimes simply called connectors), hubs (sometimes called gateways or routers) or central connectors. Alternatively, they may be described functionally. Simple connectors are directed to communicate via hub connectors, except when they are permitted to communicate P2P among connectors in the same sub-community. So-called hubs are used by connectors that are explicitly directed or linked to them. Hubs may serve more than one function and, accordingly, may appear more than once in a route from a source to a destination. Hubs forward electronic commerce documents or messages. Hubs also may translate among transport protocols that support a common envelope protocol. For instance, a hub may translate envelope protocols and also implement a different transport protocol upon transmission than upon receipt. A central connector is a special case of a hub, which can be used by connectors that are not explicitly directed or linked to them. A central connector is useful, for instance, to carry out translation functions when traversing connectors from a source according to routing rules does not lead to any hub that supports the transport/envelope protocol used by the destination.

Aspects of the present invention address federated registries, components of an interoperability contract data structure, dynamic negotiation of the interoperability contract. The scope of a registry is a community. A community can be an enterprise, a marketplace or a sub-enterprise in a larger distributed enterprise. The parties who interoperate might be in different communities. For example, one might be in a suppliers community and another might be in a buyers community. Therefore, a federated scheme for storing profiles and agreements should be used. For interoperation, the present invention goes beyond ebXML and other conventional approaches to e-commerce interoperation. An interoperability contract is extended to include combinations of the following: The route to follow in conveying messages between the services, conforming to defined routing rules. For example a rule might say that all messages to/from a web service should be fronted by a particular router. The route includes automatic routing through gateways for envelope transformations, such as between SOAP and EDI envelope protocols. The signing, authentication and encryption policy on a message part by message part basis is specified, as there can be multiple parts in a message, where the policy includes the algorithm, the technology (for example XML encrypt, SMIME, PKCS#7) and elements (for example an XML element in an XML document.) The transformation rules are specified for documents included in message parts, on a part-by-part basis. For example, if transformation for version interoperation is permitted and if so if the original should be attached. Specific transformation logic also can be identified. The version of the message exchange choreography to be used is identified. For example, a service might support multiple versions of a choreography, so services benefit from knowing the right version that the sender and receiver support. Certain message conveyance policies are set, such as whether to archive messages, to use reliable delivery, and to require a non repudiation receipt of acknowledgement. Differences in sent and received messages that need to be bridged are addressed by envelope adjustment or envelope transformation. For example different envelope extensions used, differences in message part order, different envelope protocols. The connectors in the route that serve various interoperation functions, consistent with on capabilities of the connectors, are registered in the registry. One of skill in the art will recognize that the preceding and following aspects of the present invention can be combined in many useful subsets; the invention is not intended to be limited to an interoperability contract that includes all aspects of the present invention.

The interoperability contract is normally derived by intersecting the policies and interfaces of the sender and receiver services. However, overrides are possible that indicate decision rules that should used to resolve conflicts between the sender and receiver. For example decision rules may determine that sender wins, receiver wins, most stringent policy wins, etc. This is useful for supporting service modifications, as the interoperation contract is computed and signed by a trusted service, such as a community root party who is trusted. The interoperability contract may be dynamically computed when a service is invoked and may be locally cached at the message sending site.

When the invoking service is in one community and the invoked service is in another community, the contract calculation may be performed by a distributed logic that gets the send side and receive side information from community registry local to both services and intersects it. Any overrides is defined on the receive side and send side are noted and copied to the complementary side for approval, if there is no prior approval. At contract creation time, the resulting interoperability contracts, calculated on a distributed basis, end up being the same, as a cross community online negotiation process can be used to address the overrides. Much complexity is hidden from the service writer and the interoperation contract is automatically deduced from the registry. This greatly simplifies service development.

The interoperability contract should be dynamically computed to avoid major synchronization problems by installing the contracts in local machines. This does not necessarily require re-computation for each message, as a cache can supplement the dynamic computation. The cache could be kept coherent by invalidation notifications on changes in the registry or expiration policies. A cache keeper could subscribe to any required notifications. The interoperability contract can be dynamically computed upon initiation of a web service from the sending services connector (or a proxy for it that knows how to handle it). The contract may be attached to a message after computation, so that intermediate connectors between the communicating services understand their roles in the message exchange. For instance, the contract can specify which connector should perform version transformation, signing, encryption, etc.

Aspects of the present invention extend across multiple dimensions of interoperability. For true end-to-end message interoperation, there are many dimensions of interoperability to address. Addressing any one dimension of interoperability advances e-commerce using web-based services. Addressing combinations of interoperability issues can produce significant advances. In the discussion that follows, more than a dozen dimensions of interoperability and solutions within the scope of the present invention are presented.

1. Transport Protocol Interoperation

One dimension of interoperation is transport level interoperation. According to aspects of the present invention discussed more fully in the related applications, the allowed and supported transports are tied to the envelope protocol used. In contrast, in ebXML the allowed transport is HTTP(S). For MML, the allowed transport is Sonic. For Biztalk, the allowed transport is HTTP(S). In one embodiment of the present invention, the allowed transports are HTTP(S) and sonic.

With sonic, the reliability is pushed down to the transport level. The sonic reliability protocol is an extremely good algorithm. Long term, HTTP(S)R, if standardized, may provide reliability at the HTTP(S) level itself. The solution used now by ebXML and Biztalk is reliability with a envelope protocol dependent approach over HTTP(S). SOAP, without extensions, provides no support for reliability at the envelope level.

The present invention includes support for negotiation of a transportation protocol among to supported protocols. In one embodiment, this involves a choice between HTTP(S) and sonic. As additional transports are adopted for e-commerce, the present invention can include those additional options in negotiations.

2. Envelope Protocol Interoperation

In one embodiment of the present invention, the envelope protocols supported are MML, C1 SOAP, email, and external SOAP, which allows any combination of optional extensions like C1 address, conversation and message info, manifest, SAML and SOAP with attachments. Services exposed with pure SOAP, SOAP WA, standard WSDL and discoverable with UDDI are called simple web services in the industry. However C1 SOAP, while inter-operating with endpoints that are simple web services (developed with third party development environments and third party execution environments) also supports native web services with reliability, security, and participation in bi-directional choreography. Back office systems exposed with J2EE CA or EJBs can be wrapped as a simple web service by third parties. This embodiment can interoperate with them, as well as supporting email protocols and external SOAP.

Supported protocol define allowed transport, reliability and security protocols. They also defines the way services and parties are addressed in that protocol and data linkages to tie related messages together. Message routing and dispatching are based on the address defined.

Envelope protocol determination and transformations can be supported by the interoperability contract. This is one of the ways in which the interoperability contract goes far beyond a typical ebXML CPA contract. Again, the interoperability contract may include information about the route to follow, the transformations to do and where to do them, things to be signed or encrypted ands where to do it and what algorithm to use, the name and version of the choreography, and the sending/receiving TP/service/service version/operation. The interoperability contract can be used to drives intermediate connectors along the route between services. The segment of the route between participating services is the so-called “intelligent interoperable network,” which adds value even if the endpoints strictly follow standards without using software developed by the assignee of this patent.

Interoperation between envelope protocols is through gateways. Different versions of the same protocol may be treated as different protocols. The router knows to transparently route a message through the appropriate set of gateways for interoperability. The dispatcher in the destination connector hands an inbound message to the appropriate component. This dispatching again is based on rules driven by the target address and other envelope fields.

One variation of envelope protocol interoperation is where we have a protocol with a baseline and multiple options that can be used. An example is external SOAP, with SOAP with attachments, routing, security, SAML etc. being optional. If the sender specifies one set of options and the receiver specifies another set, the point of entry into the network would compute if interoperation is possible and if so how. It would automatically add optional blocks based on rules and strip unwanted blocks at a point of exit from the network.

When we transfer XML data from a SOAP body to a document in a MIME part or vice versa, we could consider this to be a form of envelope interoperation. Such transformations occur when transforming between Biztalk and ebXML or SOAP and ebXML. It also occurs for SOAP-to-SOAP interoperation where the sender puts the payload in an attachment and the receiver expects it in the body (or vice versa).

3. Security Protocol Interoperation

One issue with envelope protocol interoperation is that the security protocol supported is defined by the envelope protocol and transforming between security protocols is near impossible. For example, switching from XML signature supported by envelope protocol A to PKCS#7 supported by envelope protocol B is not possible. If the receiving service requires the original signature or encryption for interoperation, the gateway should return an error to the sender, unless the gateway is trusted to transform security protocols. One approach to overcoming security protocol incompatibilities is to trust the gateway to verify the signature in the message and decrypt (the encryptor uses the gateways key) and resign and re-encrypt messages. A trust scheme is instituted, whereby the gateway's signature can be trusted by the receiver.

SOAP extensions proposed in the industry include WS-security (part of GXA). Embodiments of the present invention can support WS-security, including WS-security for C1 SOAP. At this time, such security extensions are optional and if a foreign web service has not adopted WS-security, it could delegate to the point of entry into the interoperability network the authority to sign and encrypt messages on its behalf (the point of entry has access to the user key). This works if the point of entry into the network is located within the enterprise with the foreign web service.

No message should be accepted into the interoperable network without being authenticated first (unless the invoked service expressly does not care).

One aspect of security protocol interoperation is when the sender and receiver specify different security policies and capabilities. The interoperation framework has to compute if interoperation is possible and if so how.

4. Interoperation Between Different Types of Services

Typically, services are registered in the collaborative registry unless noted otherwise. In the context of this discussion, it is expected that a collaborative web service will interact at least one interface with another collaborative web service.

There are so-called simple, high performance and collaborative web services. There are also native and foreign web services. Lastly there are registered and unregistered services. A simple web service does not use signing, encryption, reliable messaging and does not require authentication from a central trusted party. It also does not support bi-directional choreographies. In other words, each invocation of a simple web service is independent of all previous invocations of the simple web service and there is no choreography context being kept in the simple web service, and no knowledge of return addresses in the context so it can reply back later. A high performance web service can include better reliability and security. A collaborative web service can be simple or high performance and in addition support bi-directional choreographies. Typically, web services other than those prepared by the assignee of this application (foreign web services) are simple web services.

As described throughout this application and the incorporated applications, aspects of the present invention can extend the mechanisms for e-commerce in numerous ways. Innovative web services can be registered in the collaborative registry as are high performance web services and collaborative web services. Support can be provided for a continuum between native simple and high performance web services where elements can be added one by one. A high performance web service can declares in the registry what elements it supports. It will be possible to download the WSDL definition of an innovative native simple web service (from UDDI or from Commerce One's own collaborative registry), which identifies a service port that is the URL of a point of entry into the network. Messages conveyed through the port of entry will automatically be routed from there to their logical destinations. Messages routed in accordance with the present invention include or are governed by an interoperability contract that governs what happens at every hop. Native web service can invoke a native or foreign simple web service.

Foreign simple web services can be supported by an innovative network. If the foreign web service knows the innovative addressing and message identity and correlation SOAP extensions, it could even participate in bi-directional choreography as a collaborative web service. Foreign web services may use a combination of innovative SOAP extensions. They do not need to access a community registry or understand an interoperability contract. The present invention could be extended to provide software to build foreign web services and third party software should be used. Foreign web services can be invoked by any native web service or any other foreign web service through our network. Foreign web services can use external SOAP or email. In the case of email, a human user using an email browser could “implement” the web service and interoperate with both simple and collaborative native or foreign web services. The WSDL definition of the foreign web service can be downloaded from the collaborative registry or from UDDI. A foreign web service invokes a web service in an innovative network by invoking a URL at a point of entry into the network. A collaborative foreign web service is provided the URL of the point of entry into our network in a SOAP extension as part of invocation by a native collaborative web service, so it can dynamically respond back later if it understands the SOAP extension.

5. Network and Location Independent Interoperation

The location of the destination services component should not matter and the marketplace or enterprise community that the service is registered in should not matter. The routing algorithm should transparently handle location transparency and marketplace or enterprise community transparency. Routing along with the transport and security mechanism should support automatic tunneling through appropriate enterprise and marketplace firewalls without compromising security.

6. Platform Independent Interoperation

A platform may include the hardware/operating system the software runs in and the development and execution environment of the server the business service runs in. It also may involve the server technology (J2EE app server, web server, servelet runner) the software runs in. The hardware part of independence can be achieved by using 100% pure Java. The independence from development/execution environment can be achieved by supporting strict standards based wire level interoperation with foreign connectors and servers. The server technology independence can be achieved by making components embeddable and conforming to J2EE standards.

When vendor supplied components are platform independent, a customer can develop services using their preferred development/execution environment from their preferred favorite vendor and accessed with their favorite client side tool. Such services can still interoperate with vendor developed services with interoperation value added by the intelligent network, and all services can be composed into more complex services with composition capabilities using a process flow engine.

A light weight commerce web services server can be deployed based primarily on message interoperation components. A lightweight server would be targeted for supplier connectivity, gateway writers and for the ISV market. A more complete embodiment of a collaborative web services server that is a superset of the lightweight edition. The lightweight edition includes basic development tools for document related development, but primarily leverages third party tools for service development. A sophisticated full development environment for UI and document based process centric self-contained or composed services may be included with the collaborative web services server embodiment.

7. Back Office System Interoperation

One aspect of interoperation with foreign connectors is interoperation with back office systems. Aspects of the present invention allow back office systems to be exposed so that the look just like a plurality of services from a messaging level and from a discovery level. Toolkits will allow back office system operators to expose their interfaces as simple web services, or wrap their custom adapters as a web service. Custom integration brokers will be able to integrate established EAI technologies with the innovative messaging system or to directly construct a web services interface. Another embodiment of integration with a back office system is email support. An email server can be used to integrate a back office system with the innovative network.

Exposing back office systems as web services could involve specialized transformation schemes not based on XML. Examples are transforming between DB and XML or XML and flat files, or transforming between J2EE CA 1.0 record structures and XML. All this is hidden from downstream web services and transparent to downstream web service developers.

8. Service Discovery and Cross Community Interoperation

In the future, it is likely that interoperation between trading partners will become more dynamic. A discovery mechanism is a useful to find a trading partner to do business with, before setting up the business relationship. Discovery of services and trading partners offering them is done through the UDDI standard. A more powerful tool that UDDI supports is invoking innovative registry web services. Inventions related to the present invention will provide support for uploading data to a public UDDI registry or to a private UDDI registry that serves as yellow pages for a community or a set of communities. Discovery across the network of communities is possible.

For discovery across communities, each community may have a list of global white page communities or global yellow page registries associated with it. Global white page communities contain transport addresses for routing a request into a set of advertised communities. Global yellow page registries contain the trading partners and services of a set of advertised communities along with aliases and categories. Searches are done by categories. Since interoperation is bi-directional, two communities can subscribe to a common global white page community or have routing information to each other directly within their community registries. Two communities can discover objects in each other if they subscribe to a common yellow page registry. Typically, a yellow pages registry is hosted within a white page community.

Programming registry access interfaces are supported for not only discovery, but also trading partner information including roles and privileges, and users and organizations and their relationships. Also there is support for getting the technical information for interoperation including WSDL files, service interfaces, transformation code and schema files.

9. Registry Version Interoperation

Registry services may be configured as other web services and benefit from the interoperability support of all services.

10. Document Semantic Interoperation

The infrastructure does not care about the semantics of the payload. However document semantic interoperation is what allows services using differing document to enjoy end-to-end interoperation. The sender and receiver have to agree to the document semantics, such as document family members and transformation among the members, to facilitate interoperation. For interoperation with back office systems, document standards may include Idocs and OAGI.

11. Document Version Interoperation

The interface of a receiving operation in a service can define support for one or more versions of a document. The innovative version interoperation system transforms between the sent document and the expected document to be received and tries to reduce loss by picking the best-received version. The transformation occurs before the message is signed and encrypted on the send side.

The registry supports major and minor versions within document families. Major versions may conform to different schema languages. Minor versions are expected to add optional parts to a base version.

12. Schema Language Interoperation

The schema languages for payload XML documents are defined by the envelope protocol. Examples of schema languages are SOX and XSDL. These are languages to describe the schema of an XML document. An XML instance of a schema in one language is different than an XML instance of an equivalent schema in another language. Therefore, schema language instance transformations should be supported by transformations in gateways.

Gateways may perform so-called syntactic transformations where the structure of the payload (relationship of elements) and semantics is not changed but the syntax and packaging is changed. A compatible structure is converted to an exact equivalent XML markup and vice versa.

13. Dependency on Location and Order of Interoperation Steps

From this discussion, those skilled in the art will see that the interoperability contract is one way of assuring that interoperation steps are carried out at agreed locations and in an agreed order. A message from sender to receiver travels through a series of connectors where different connectors do various steps for interoperation. There is interplay between the location and order of schema language instance transformation, version transformation, envelope transformation, signing, and encryption. The infrastructure properly orders the transformations.

14. Service Version Interoperation

Web services are defined by how they appear outside, in terms of their registry description and when addressing messages to them. It will be natural for a service to be upgraded and a service version to change over time. A new version of a service might have added operations or added or deleted optional parts in an existing message. It might also have changed the set of choreographies supported and the location of a part in the message. Choreography interoperation described can be used to allow senders to know if they should invoke the new operation. In addition, the version numbers of the services are made known to the sender and receiver, so they can respond appropriately.

The infrastructure takes care of interoperation when the set of optional parts are different or when a body part becomes an attachment or vice versa.

15. Choreography Interoperation

There are at least two embodiments that support choreography. One embodiment defines a process flow and has all participants run their messages through this process. The process flow runs in a process flow engine in a service. Another embodiment supports direct messaging between the endpoint services with knowledge of the choreography details in the endpoint service themselves. A process flow engine process sends and receives messages with other services and therefore can be made to look like a service itself. This abstraction can be very useful.

Process flow engine processes should appear as a service. The applications that want to interact with the process send to and receive messages from this service. Because of this abstraction, the process flow engine process can also be used to compose a bigger service by using the process definition to tie together a set of services into a flow and expose the larger service. Moreover, a process flow engine process engine can be made available in every innovative service and therefore distributed processes can be built that span across multiple process engines. This is possible because each sub process in the distributed process looks just like a service and a sub process invoking another sub process is treated just like a service invoking another service. The various sub processes interact with messages and the messages could carry process flow context available in each sub process to more tightly integrate the sub processes.

A consideration in bi-directional choreographs between services is the ability to know the sending TP/service/operation, particularly when one of the services does not directly support choreography or conversation ID extensions. A method to correlate related messages with conversation ID is useful. It is possible to have a virtual conversation with a simple web service, which does not support choreography by using payload data to correlate related messages that form the conversation. A process flow engine includes logic and resources to perform the correlation. For messages from foreign connectors without the addressing extension (typically true with back office systems) the message could be sent to a fixed service that looks at the payload, the registry or a local database to deduce the destination address before forwarding the message on. This capability is called logical routing and process flow engine facilitates this, based on a configured specification of fields in the payload to examine, from which the conversation ID can be inferred.

16. Choreography Variation Interoperation.

Choreography ties a set of service types offered by the participants together. All variations of a choreography form a family where the first message are substantially the same. There should be only one family supported between two services that interoperate and the choreographies in that family could be ordered by preference. However a service might support multiple families of choreographies involving different combinations of services. Choreographies can be multipolar.

In one embodiment of choreography negotiation, when the first message in the choreography is sent, the sender and the receiver are told the choreography variation picked by the system. The choreography between these can then not change. They then adjust their processing accordingly. If a new service is added to the conversation, the sending service may chose between acting as a bridge between choreography variations supported by different services in a multipolar choreography or forcing use of the selected choreography. Choreography negotiation is further described in one of incorporated, commonly owned applications.

17. Hiding the Complexities of Interoperation

Services that interact in accordance with aspects of the present invention may need to know little or nothing about interoperation, as the complex issues can be taken care of under the covers. New modules to implement interoperation can be configured. These modules take care of the complex issues related to interoperation driven by registry metadata. API abstractions can be provided to hide the envelope structure completely and hide as much as possible of the envelope specific field semantics and syntax. All the security policies can be included in the interoperability contract, simplifying the service developer's efforts to implement applications.

18. Mechanisms to Limit Interoperation

One barrier to true interoperation is security. The model is that the infrastructure authenticates the sender and the service authorizes it possibly based on metadata captured by the registry. The barriers include business rules, subscriptions and hidden services. Business rules sometimes should limit interoperation across communities or within a community. Subscriptions may be required before interoperation, as indicated by the provider's service policy. It also is useful to have hidden services that are not visible outside the community or are only visible to specific parties.

FIG. 2 illustrates the usefulness of a dynamically negotiated interoperability contract between a producer service and a consumer service. The principal features of the figure include a registry 201, a web services engine 202 including logic to dynamically determine an interoperability contract, a producer service 203 that exposes a choreographed interface to an internal process flow 204, and a consumer service 205. The figure text indicates that this example involves an order receiving system that produces order acceptances. The producer and consumer services have their own capabilities and policies for choreography, service version, documents, security authentication, security encryption, security signing, envelope protocol and transport 213, 215. A dynamically negotiated interoperability contract reduces the extent of pair wise configuration required to set up or maintain a web of services. It provides unambiguous rules for resolving differences between policies set by participants. As the participating services evolve, the dynamically negotiated interoperability contract evolves too.

Dynamic negotiation of an interoperability contract presents a remarkable deviation from conventional approaches that more nearly approximate legal contract negotiation. Dynamic negotiation begins from a producer service's description of its availability, capabilities and policies. A consumer service can readily discover the producer service using a discovery protocol such as UDDI. The producer and consumer have machine-readable specifications of their capabilities and policies. One or more schemas recognized by the producer and consumer unambiguously defines how the respective parties capabilities and policies are to be interpreted and intersections found. Instead of inviting negotiation to resolve differing interoperability terms, the system provides decision rules regarding how to resolve two types of conflicts: conflicts between preferences for alternative options and conflicts regarding whether to apply security measures such as signing and encryption to particular parts of messages that will be exchanged according to the dynamically negotiated interoperability contracts. The decision rules for preferences may be standard rules, such as receiver wins, sender wins, most stringent requirement wins, least stringent requirement wins or a weighted consideration of both parties' preferences is applied. The decision rules for whether to apply security measures, for instance, are similar. These decision rules, including overrides, are further discussed in the Dynamic Negotiation Of Security Arrangements Between Web Services patent application filed concurrently with this application and incorporated by reference. In some instances, the producer may require subscriptions before consumers can interact with the producer. This may facilitate credit and authentication checks and the like. The framework of intersections and decision rules allows a trusted software agent to dynamically negotiate an interoperability agreement, especially if a subscription has been accepted by a producer. This use of a trusted software agent authorized to dynamically negotiate an interoperability contract is a remarkable departure from the more conventional CPA-styled interoperability agreement that is cryptographically signed by both producer and consumer before it can take effect. (While this description is stated in terms of producer and consumer services, to assist the reader's understanding, it applies equally to two or more services, irrespective of their roles as producer, consumer, intermediary or otherwise.)

A set of schemas and sample interoperability contract provide additional detail regarding aspects of the present invention.

The schema Interoperability.XSD, in the source code appendix, can be used to model an interoperability contract, including several aspects of the present invention. In this embodiment, the machine-readable output files is an XML document. In other embodiments, other data structures may be used to store the same information, for instance a tree structure modeled after the XML code. The schema Interoperability.XSD is best understood by loading the file into an integrated development environment (IDE) such as XML Spy TM, which provides several alternative views of the schema, including a documentation generation view. Viewed in Spy's schema design view, Interoperability.XSD components include a general contract section, a routing contract section, a transformation contract section, a security contract section and a contract signature. The four sections each incorporate by reference another schema, which is discussed below. The contract signature, unlike conventional interoperability contracts, is applied by a software agent trusted to negotiate the contract. Separate signatures of the parties to the contract are not required. Parts of the contact signature includes the SignedInfoType, the SignaureValue, KeyInfo and the ObjectType, as further documented in the source code.

The schema GeneralContract.XSD, also in the source code appendix, can be used to model the general section of an interoperability contract, including several aspects of the present invention. GeneralContract.XSD components include to and from information, ErrorHandling, and DeliveryReceiptHandling. The components optionally include RequiredMessageParts and OptionalMessageParts, and sending and receiving connector capabilities. The to and from information relates to the party/service/activities involved. The error-handling component describes capabilities and optionally identifies where to send error messages. Like ErrorHandling, DeliveryReceiptHandling is a capability parameter with an optional address for messages. Delivery receipts are used to implement non-repudiation. The required message and optional parts are as named. The role of required and optional parts in service versioning and document family versioning is more fully discussed in the incorporated applications. The sending and receiving connector capabilities list the attributes of the connectors and the values of the attributes (such as capable of signing or encryption.) The capabilities are optional, because they may not appear for non-collaborative requests or for one-way messages. These components are further documented in the source code.

The schema RoutingContract.XSD, also in the source code appendix, can be used to model the routing section of an interoperability contract, including several aspects of the present invention. Viewed in Spy's schema design view, RoutingContract.XSD components specify a route. A Route includes two or more RouteNodes in the route, including the sender and receiver. Entry and exit channels to nodes are defined by the transport and envelope protocol used to reach or when exiting from a node. The symmetry of this information allows the exit and entry channels to reverse roles for a reversed route. This schema is further documented in the source code. Routing is more fully discussed in the incorporated applications.

As addressed in one of the concurrently filed applications, negotiation of security arrangements is carried out by a computer-based process that uses security profiles of sending and receiving services to determine a mutually agreeable security arrangement. Preferably, this security arrangement is negotiated or potentially updated regularly, without user intervention. This arrangement may be negotiated, updated or checked for validity at a user request or without user intervention whenever messages are exchanged or on some other periodic or occasional basis, such as monthly, weekly, daily, on occurrence of an event that impacts exchange of messages between a particular sender and receiver (e.g., a software component failure or a change in security preferences), when a previously negotiated arrangement fails, or on some other periodic or occasional basis. The schema SecurityContract.XSD, in the source code appendix, can be used as a model for preparing a machine-readable security interoperability contract document. In this embodiment, the machine-readable document is an XML document. In other embodiments, other data structures may be used to store the same information, for instance a tree structure modeled after the XML code. This schema defines policies and channels for security policies. A security channel defines resources and routes to resources that carry out security algorithms, such as signature, encryption and authentication algorithms. It also may include non-repudiation and authorization resources.

A set of computed security arrangements are partially reproduced below:

```
<SecurityContractICD ... >
  <SecurityPolicies>
    <SignaturePolicies>
      <XMLDsigPolicy PolicyId=“P-XMLSignatureRSA-MD5-C14N”>
      <SignaturePolicyAlgorithm>...</SignaturePolicyAlgorithm>
        <SignatureAlg...>MD5withRSA</SignatureAlg...>
        <HashFunction>MD5</HashFunction>
        <Canonical ...>... 14n-20001026</Canonical ...>
        <Transform>...#RoutingSignatureT...</Transform>
      </XMLDsigPolicy>
    </SignaturePolicies>
    <EncryptionPolicies>
      <XMLEncryptionPolicy PolicyId=“P-XMLEncrypt3DES-RSA-2048”>
  <EncryptionPolicyAlgorithm>http://www.w3.org/2001/04/xmlenc#</EncryptionPolicyAlgorithm>
        <EncryptionMethod>http://www.w3.org/2001/04/xmlenc#3des-
cbc</EncryptionMethod>
        <KeySize>2048</KeySize>
  <KeyEncryptionMethod>http://www.w3.org/2001/04/xmlenc#rsa-
1_5</KeyEncryptionMethod>
      </XMLEncryptionPolicy>
    </EncryptionPolicies>
    <EncryptionKeyInfo KeyOwner=“x-
ccns:commerceone.com:CollaborationParty::sellParty”>
      <PublicKeyID>DefaultTestCert</PublicKeyID>
      <X509Data>  <X509Certificate>LS0tLS1... ==</X509Certificate>
      </X509Data>
    </EncryptionKeyInfo>
  </SecurityPolicies>
  <SecurityChannel channelId=“CHANNEL1” sourceConnector=“x-
ccns:cup.commerceone.com:connector::centerSell” targetConnector=“x-
ccns:cup.commerceone.com:connector::centerSell”>
    <Confidential AlgorithmId=“P-XMLEncrypt3DES-RSA-2048”>
      <PublicKeyName KeyOwner=“x-ccns:commerceone.com:CollaborationParty:
:sellParty”>DefaultTestCert</PublicKeyName>
      <MessagePart PartName=“Order” isOptional=“false”/>
      <MessagePart PartName=“Image” isOptional=“false”/>
    </Confidential>
  </SecurityChannel>
  <SecurityChannel channelId=“CHANNEL2” sourceConnector=“x-
ccns:cup.commerceone.com:connector::buy” targetConnector=“x-
ccns:cup.commerceone.com:connector::sell”>
    <Integrity AlgorithmId=“P-XMLSignatureRSA-MD5-C14N”>
      <PublicKeyName KeyOwner=“OwnerA”>BuyerPublicKey</PublicKeyName>
      <MessagePart PartName=“Order” isOptional=“false”/>
    </Integrity>
  </SecurityChannel>
</SecurityContractICD>
```

This set of security arrangements has two major sections for security policy and security channels. In this example, there is one security policy applicable to the entire message and multiple security channels to implement parts of the security policy. The security policy section sets out the signature policy, and encryption policy and encryption key information. It also may set out policies regarding authentication, authorization and non-repudiation of sending or receipt. In this embodiment, the same signature and encryption policy is applied to all parts of the document. In other embodiments, multiple algorithms could be applied to different parts or different elements within a part. The algorithm selected for signature, encryption and authentication are abstracted through templates containing options sets, simplifying the selection of algorithms. Selected algorithms are associated with logic and resources, so different services or processes can be used for signing/verifying and encrypting/decrypting different parts of a message. A public key or certificate can be transmitted in the encryption key element of the security policy section. The security channel section describes services or connectors involved in applying security policies. For a particular policy, the channel section identifies a source connector that requires assistance in applying a security policy (e.g., the sending service requesting encryption), and a target connector that applies the security policy or acts as an intermediary to logic and resources that apply the security policy. For a particular security policy, such as signing, encryption, authentication, authorization or non-repudiation, specific information required to carry out the security policy is provided in the security channel section.

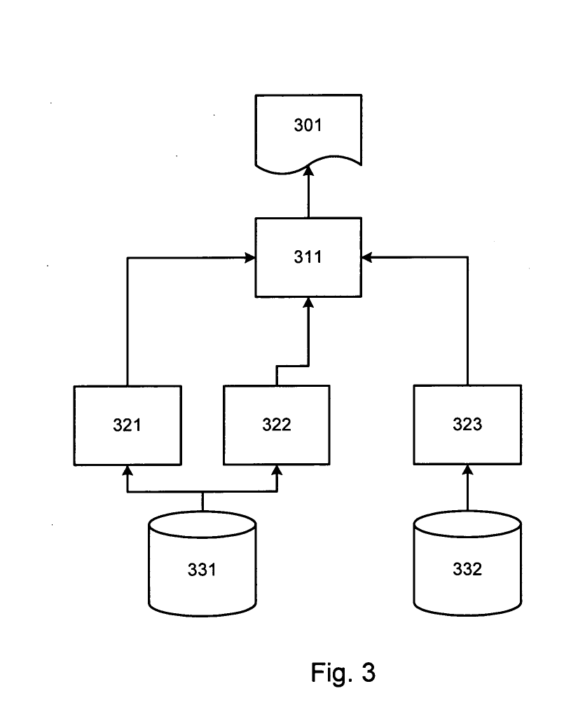

FIG. 3 illustrates alternative embodiments for obtaining receiver's information when the sender is local to calculations of the security, transformation and other arrangements. In the figure, local 331 and remote 332 registries are indicated. In this example, the sender is local and the receiver remote. The sender's data is current and complete in the local registry 331. The sender's information is collected 321 and made available to the logic and resources that compute the security arrangements 311. The receiver's data may be current and complete, for instance if the receiver is in the same community as the sender and there is a community-wide registry, or if the receiver's information has been recently obtained and locally cached. Depending on where the receiver's information can be found, 331 or 332, a process 322 or 323 is invoked to collect the receiver information and make it available to the logic that computes security arrangements. A set of security arrangements 301 result.

Two types of preferences may need to be reconciled. Both community and service-specific preferences may be stated. One type of preferences is among algorithm templates. A decision rule for choosing between options B and D might take into account one or both of the messaging services' preferences. For instance, the receiving service's preference (D) for signature or the sending service's preference (B) for encryption might be selected from among the matches. Taking both preferences into account, the most stringent (B) or the least stringent (D) might be selected. In another embodiment, the respective services might weight or score their preferences and a combined weighting or score may be used to take into account both preferences. The second type of preferences is for whether or not to sign or encrypt a part of a message. Decision tables may be used to implement the type of preference reconciliation related to whether to sign or encrypt part of a message. Again, decisions could be biased to accept preference not to sign or to accept the receiver's preference, or just the opposite. Some decision tables that could be used to implement possible decision rules follow:

Sender Preference

| | | Signature | Signature | |
|---|---|---|---|---|
| | | Required | Optional | No Signature |
| Receiver | Signature | Sign | Sign | Error |
| Preference | Required | | | |
| | Signature | Sign | Don't Sign | Don't Sign |
| | Optional | | | |
| | No Signature | Error | Don't Sign | Don't Sign |

Sender

| | | Encryption | Encryption | |
|---|---|---|---|---|
| | | Required | Optional | No Encryption |
| Receiver | Encryption | Encrypt | Encrypt | Error |
| | Required | | | |
| | Encryption | Encrypt | Don't Encrypt | Don't Encrypt |
| | Optional | | | |
| | No | Error | Don't Encrypt | Don't Encrypt |
| | Encryption | | | |

Sender

| | | Signature | Signature | |
|---|---|---|---|---|
| | | Required | Optional | No Signature |
| Receiver | Signature | Sign | Sign | Sign |
| | Required | | | |
| | Signature | Sign | Don't Sign | Don't Sign |
| | Optional | | | |
| | No Signature | Don't Sign | Don't Sign | Don't Sign |

Sender

| | | Encryption | Encryption | |
|---|---|---|---|---|
| | | Required | Optional | No Encryption |
| Receiver | Encryption | Encrypt | Encrypt | Encrypt |
| | Required | | | |
| | Encryption | Encrypt | Don't Encrypt | Don't Encrypt |
| | Optional | | | |
| | No | Don't | Don't Encrypt | Don't Encrypt |
| | Encryption | Encrypt | | |

These formats for security decision rules apply with equal force to other preference negotiations. In some special cases, such as transformation, metrics of information loss or transformation accuracy may be applied, as described in the incorporated applications.

The schema TransformationContract.XSD, also in the source code appendix, can be used to model the document transformation section of an interoperability contract, including several aspects of the present invention. Viewed in Spy's schema design view, TransformationContract.XSD components specify one or more documents to transform and optionally specify response documents. DocumentToTransformType includes a source document ID and part name, and a receiver attachment preference flag. It optionally includes an attachment part ID and one or more transformation maps, that describe how to implement a transformation. This schema and particularly the transformation maps are further documented in the source code. Document transformation is more filly discussed in the incorporated applications.

A partial example of a computed interoperability contract is provided in InteroperabilityContract.XML, in the source code appendix. This example includes general, routing and transformation contract sections. See above for an example of a security contract section. The example is largely self-explanatory to those of skill in the art, particularly with the accompanying schemas available. Some highlights follow. The general contract section identifies this as contract as governing a collaborative interaction. Messages are archived for non-repudiation, error handling and other uses. Utilities are allowed to consider messages governed by this contract in compiling aggregate (or, configurably, specific) business intelligence information. A from address is given for a buyParty ConsumerOrderManagement sendOrder activity. A historical DDID number or address further identifies the sending service. A receiving address is given for sellParty providerOrderManagement process order activity. The sender accepts asynchronous error messages using a C1 SOAP 1.0 envelop protocol to a specified address. The sender requires a delivery receipt, which the receiver can generate asynchronously. The required message parts or documents are Order and Image. Optionally, a someXMLPart can be included. Sending and receiving connector capabilities are enumerated for signing, encryption, archiving, message envelopes, manifest types, and delivery receipt types. A sample general contract section is part of the example in the source code appendix.

In addition to the general contract section, there are a routing contract section and a transformation contact section. The sample routing contract section follows:

```
<RoutingContract>
    <route:RouteNode preICDComputation=“false” connector=“x-
gtw:cup.commerceone.com:connector::default” isNative=“true” connectorFunction=“service-
send”>
      <route:EntryChannel envelopeProtocol=“C1 SOAP 1.0”
transportSupportedMessageType=“both”
transportPhysicalAddress=“icdtest.commerceone.com::SOAP_buyspicenutmeg”
transportProtocol=“SONIC” transportNative=“true” transportReliable=“true”/>
      <route:ExitChannel envelopeProtocol=“C1 SOAP 1.0”
transportSupportedMessageType=“both”
transportPhysicalAddress=“icdtest.commerceone.com::SOAP_buyspicenutmeg”
transportProtocol=“SONIC” transportNative=“true” transportReliable=“true”/>
    </route:RouteNode>
    <route:RouteNode preICDComputation=“false” connector=“x-
gtw:cup.commerceone.com:connector::default” isNative=“true” connectorFunction=“service-
receive”>
      <route:EntryChannel envelopeProtocol=“C1 SOAP 1.0”
transportSupportedMessageType=“both”
transportPhysicalAddress=“icdtest.commerceone.com::SOAP_buyspicenutmeg”
transportProtocol=“SONIC” transportNative=“true” transportReliable=“true”/>
      <route:ExitChannel envelopeProtocol=“C1 SOAP 1.0”
transportSupportedMessageType=“both”
transportPhysicalAddress=“icdtest.commerceone.com::SOAP_buyspicenutmeg”
transportProtocol=“SONIC” transportNative=“true” transportReliable=“true”/>
    </route:RouteNode>
</RoutingContract>
```

This sample illustrates application of the schema described above. Similarly, the sample tranformation contract, illustrating application of the transformation schema, follows:

```
<TransformationContract>
  <xform:DocumentToTransform>
  <xform:SourceDocID>publicid:com.commerceone.schemas:PurchaseOrder:3.5</xform:
SourceDocID>
    <xform:PartName>PurchaseOrder</xform:PartName>
    <xform:Attachment>false</xform:Attachment>
    <xform:TransformationMap>
      <xform:Connector>x-gtw::lion-z-
01.lion.commerceone.com::connector::buyspicenutmeg</xform:Connector>
      <xform:StartDoc>
  <xform:DocURI>publicid:com.commerceone.schemas:PurchaseOrder:3.5</xform:DocURI>
        <xform:DocName>PurchaseOrder</xform:DocName>
    <xform:Namespace>publicid:com.commerceone.schemas</xform:Namespace>
        <xform:Version>3.5</xform:Version>
      </xform:StartDoc>
      <xform:EndDoc>
  <xform:DocURI>publicid:com.commerceone.schemas:PurchaseOrder:4.0</xform:DocURI>
        <xform:DocName>PurchaseOrder</xform:DocName>
  <xform:Namespace>publicid:com.commerceone.schemas</xform:Namespace>
        <xform:Version>4.0</xform:Version>
      </xform:EndDoc>
      <xform:CommunityID>exostar</xform:CommunityID>
      <xform:TransformationMapURI>urn:x-
commerceone:transformation:1</xform:TransformationMapURI>
    </xform:TransformationMap>
  </xform:DocumentToTransform>
</TransformationContract>
```

From the preceding description, it will be apparent to those of skill in the art that a wide variety of systems and methods can be constructed from aspects and components of the present invention. One embodiment is a machine-readable data structure that specifies interoperability data. An environment in which this machine-readable data structure is useful is for interoperation between a consuming service and a providing or producing service. These services exchange documents via a network, optionally using intermediate connectors. The machine-readable data structure may combine any two or more of the following useful data elements: a route between the services, specified by the names of the services and the intermediate connectors; a choreography version to be used for an exchange of messages; policies for archiving the messages, for assuring reliable delivery of the messages and for requiring a receipt acknowledgment; a specification assigning requirements for parts of a particular message and at least one signing algorithm to use; a specification of encryption requirements for parts of a particular message and at least one encryption algorithm to use; a specification of one or more authentication procedures to use; a specification of one or more transformation logics to apply to documents included in a particular message; and a specification of whether untransformed copies of the documents should be included with transformed copies the documents. The combinations specified in the accompanying claims are not meant to be exclusive. The permutations of two or more of the above useful data elements are hereby expressly described.

A further embodiment of the present invention is a machine-readable data structure that specifies current interoperability data prepared by a process. An environment in which this machine-readable data structure is useful is interoperation between a consuming service and a providing or producing service. The services exchange documents via a network. The services may optionally use intermediate connectors. Unlike static interoperation contracts, such as contracts that are signed by both parties, this machine-readable data structure is created by a process responsive to a request to initiate an exchange messages between the services. The processing in clues accessing interoperability data for the services, intersecting the interoperability data for the services, and, for intersections interoperability data that produce more than one mutually acceptable option, applying decision rules to select one option. This machine-readable data structure may include any permutations of useful data elements described in the prior embodiment. The decision rules used may be subscribed to by the services that are exchanging messages or may be adopted by subscription of the services to a trading community. Any of the decision rules described throughout this application may be used as a further aspect of this embodiment.

Another embodiment of the present invention is a machine-readable data structure that specifies one or more security channels. An environment in which this machine-readable data structure is useful is interoperation between a consuming service and a providing or producing service. The services exchange documents via a network. The services may optionally use intermediate connectors. The security channels apply to one or more of assigning, encryption or authentication. They also may be applied to authorization or to non repudiation, or any combination of these security-related tasks. The security channels themselves include specification of a connector originating a security-related request and a connector responding to the security-related request, and a specification of the security related request. The security-related request may include one or more of the above listed security-related tasks. This data structure including security channels may be formed responsive to request to an initiate an exchange of messages between the services.

While the present invention is disclosed by reference to the preferred embodiments and examples detailed above, it is understood that these examples are intended in an illustrative rather than in a limiting sense. Computer-assisted processing is implicated in the described embodiments. Accordingly, the present invention may be embodied in methods for computer-assisted processing, systems including logic to implement the methods, media impressed with logic to carry out the methods, data streams impressed with logic to carry out the methods, or computer-accessible processing services. It is contemplated that modifications and combinations will readily occur to those skilled in the art, which modifications and combinations will be within the spirit of the invention and the scope of the following claims.

1. A machine-readable data structure that specifies interoperability data for a consuming service and a providing service, the services exchanging documents via a network, optionally using intermediate connectors, the data structure including:
a route between the services, specified by names of the services and the intermediate connectors and a route among the named services and connectors;
a choreography version to be used for an exchange of messages;
policies for archiving the messages, for assuring reliable delivery of the messages and for requiring a receipt acknowledgement whereby repudiation of receipt can be reduced.

2. The data structure of claim 1, further including a specification of signing requirements for parts of a particular message exchanged between the services and at least one signing algorithm to use.

3. The data structure of claim 1, further including a specification of encryption requirements for parts of a particular message exchanged between the services and at least one encryption algorithm to use.

4. The data structure of claim 1, further including a specification of one or more authentication procedures to use.

5. The data structure of claim 1, further including:
a specification of one or more transformation logics to apply to documents included in a particular message exchanged between the services; and
a specification of whether untransformed copies of the documents should be included with transformed copies of the documents.

6. A machine-readable data structure that specifies interoperability data for a consuming service and a providing service, the services exchanging messages including documents via a network, optionally using intermediate connectors, the data structure including:
a specification of signing requirements for parts of a particular message exchanged between the services and at least one signing algorithm to use;
a specification of encryption requirements for parts of a particular message exchanged between the services and at least one encryption algorithm to use; and
a specification of one or more authentication procedures to use.

7. The data structure of claim 6, further including a route between the services, specified by names of the services and the intermediate connectors and a route among the named services and connectors.

8. The data structure of claim 6, further including a choreography version to be used for an exchange of messages.

9. The data structure of claim 6, further including policies for archiving the messages, for assuring reliable delivery of the messages and for requiring a receipt acknowledgement whereby repudiation of receipt can be reduced.

10. The data structure of claim 6, further including:
a specification of one or more format or protocol transformation logics to apply to documents included in a particular message exchanged between the services; and
a specification of whether untransformed copies of the documents should be included with transformed copies of the documents.

11. A machine-readable data structure that specifies interoperability data for a consuming service and a providing service, the services exchanging messages including documents via a network, optionally using intermediate connectors, the data structure including:
a specification of one or more format or protocol transformation logics to apply to documents included in a particular message exchanged between the services; and
a specification of whether untransformed copies of the documents should be included with transformed copies of the documents.

12. The data structure of claim 11, further including a route between the services, specified by names of the services and the intermediate connectors and a route among the named services and connectors.

13. The data structure of claim 11, further including a choreography version to be used for an exchange of messages.

14. The data structure of claim 11, further including policies for archiving the messages, for assuring reliable delivery of the messages and for requiring a receipt acknowledgement whereby repudiation of receipt can be reduced.

15. The data structure of claim 11, further including a specification of signing requirements for parts of a particular message exchanged between the services and at least one signing algorithm to use.

16. The data structure of claim 11, further including a specification of encryption requirements for parts of a particular message exchanged between the services and at least one encryption algorithm to use.

17. The data structure of claim 11, further including a specification of one or more authentication procedures to use.

18. A machine-readable data structure that specifies current interoperability data for a consuming service and a providing service, the services exchanging messages including documents via a network, prepared by the process of:
responsive to a request to initiate an exchange of messages between the services, accessing interoperability data for the services;
intersecting the interoperability data for the services; and
for the intersections of interoperability data that produce more than one mutually acceptable option, applying decision rules to select one option.

19. The data structure of claim 18, wherein the decision rules are subscribed to by the services.

20. The data structure of claim 18, wherein the decision rules are adopted by subscription of the services to a trading community.

21. The data structure of claim 18, wherein the interoperability data includes one or more of:
a route between the services, specified by names of the services and the intermediate connectors and a route among the named services and connectors;
a choreography version to be used for an exchange of messages;
policies for archiving the messages, for assuring reliable delivery of the messages and for requiring a receipt acknowledgement whereby repudiation of receipt can be reduced;
a specification of one or more format or protocol transformation logics to apply to documents included in a particular message exchanged between the services; and
a specification of whether untransformed copies of the documents should be included with transformed copies of the documents.

22. The data structure of claim 19, wherein the interoperability data includes one or more of:
a route between the services, specified by names of the services and the intermediate connectors and a route among the named services and connectors;
a choreography version to be used for an exchange of messages;
policies for archiving the messages, for assuring reliable delivery of the messages and for requiring a receipt acknowledgement whereby repudiation of receipt can be reduced;
a route between the services, specified by names of the services and the intermediate connectors and a route among the named services and connectors;
a specification of one or more format or protocol transformation logics to apply to documents included in a particular message exchanged between the services; and
a specification of whether untransformed copies of the documents should be included with transformed copies of the documents.

23. The data structure of claim 18, wherein the interoperability data includes:
a route between the services, specified by names of the services and the intermediate connectors and a route among the named services and connectors;
a choreography version to be used for an exchange of messages;
policies for archiving the messages, for assuring reliable delivery of the messages and for requiring a receipt acknowledgement whereby repudiation of receipt can be reduced.

24. The data structure of claim 18, wherein the interoperability data includes:
a specification of signing requirements for parts of a particular message exchanged between the services and at least one signing algorithm to use;
a specification of encryption requirements for parts of a particular message exchanged between the services and at least one encryption algorithm to use; and
a specification of one or more authentication procedures to use.

25. The data structure of claim 18, wherein the interoperability data includes:
a specification of one or more format or protocol transformation logics to apply to documents included in a particular message exchanged between the services; and
a specification of whether untransformed copies of the documents should be included with transformed copies of the documents.

26-29. (cancelled)
